(19) United States
(12) Patent Application Publication
(10) Pub. No.: US 2008/0216929 A1
(43) Pub. Date: Sep. 11, 2008

(54) MANUFACTURING METHOD OF PNEUMATIC TIRE AND PNEUMATIC TIRE

(75) Inventor: Tamotsu Mizutani, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/035,580

(22) Filed: Feb. 22, 2008

(30) Foreign Application Priority Data
Mar. 6, 2007 (JP) 2007-055562

(51) Int. Cl. B60C 11/00; B29D 30/08

(52) U.S. Cl. 152/209.1; 156/117

(57) ABSTRACT

A first conductive rubber layer is formed by arranging a filament conductive rubber within a ground surface of a shoulder portion of a nonconductive tread rubber so as to be along a tire circumferential direction, before vulcanizing a tire. Further, a second conductive rubber layer is formed by arranging a filament conductive rubber extending to an outer side in a tire width direction along an extending direction of a slit from the first conductive rubber layer and reaching a strip rubber while cutting across a ground end E, before vulcanizing the tire. Further, a tread pattern is formed in such a manner that the first conductive rubber layer vertically cuts across the slit and the second conductive rubber layer is arranged within the slit, at a time of vulcanizing the tire.

### BACKGROUND OF THE INVENTION

1. Field of the Invention

The present invention relates to a manufacturing method of a pneumatic tire in which an electric resistance countermeasure is applied to a nonconductive tread rubber having a high electric resistance, and the pneumatic tire.

2. Description of the Related Art

Conventionally, for the purpose of reducing a rolling resistance which has a strong connection to a good mileage of a vehicle and improving a braking performance on a wet road surface (a wet braking performance), there has been known a pneumatic tire in which a tread rubber is highly filled with a silica. However, since the tread rubber mentioned above has a higher electric resistance in comparison with a tread rubber highly filled with a carbon black, and suppresses a discharge of a static electricity generated in a vehicle body or the tire to a road surface, there is a problem that a problem such as a radio noise or the like is generated.

Accordingly, there has been developed a pneumatic tire structured such that a conductive layer is provided in a non-conductive tread rubber having the high electric resistance mentioned above, thereby discharging the static electricity to the road surface. For example, in Japanese Unexamined Patent Publication No. 2002-1834, Japanese Unexamined Patent Publication No. 2001-18302, Japanese Unexamined Patent Publication No. 10-81783, and Japanese Unexamined Patent Publication No. 8-230407, there is described a structure in which a conductive layer is provided by applying a rubber paste or a rubber cement onto surfaces from the tread rubber to a conductive rubber portion (a strip rubber and a side wall rubber) adjacent thereto, thereby forming a conductive path from the conductive rubber portion to a shoulder portion. However, since the conductive layer formed in accordance with the method mentioned above is formed as a thin film shape having a thickness about 0.1 mm at the most, the conductive layer is easily separated by pressing a mold surface of a forming mold, so that there is a case that the conductive path is discontinuous and a conductive performance can not be sufficiently achieved. Further, if a wear of a block edge makes progress, there is a tendency that the conductive performance cannot be secured.

### SUMMARY OF THE INVENTION

The present invention is made by taking the actual condition mentioned above into consideration, and an object of the present invention is to provide a manufacturing method of a pneumatic tire and the pneumatic tire in which a conductive layer is not easily separated even by pressing a mold surface of a forming mold, and a conductive performance can be suitably maintained regardless of a wear state of the tread rubber.

The object can be achieved by the following present invention. That is, the present invention provides a manufacturing method of a pneumatic tire for forming a tread pattern including a slit extending to an outer side in a tire width direction while cutting across a ground end from an inner side of a ground surface of a shoulder portion by pressing a mold surface of a forming mold to a surface of a tread rubber at a time of vulcanizing the tire, comprising:

a step of forming a first conductive rubber layer by arranging a filament conductive rubber within the ground surface of the shoulder portion of a nonconductive tread rubber so as to be along a tire circumferential direction, before vulcanizing the tire;

a step of forming a second conductive rubber layer by arranging a filament conductive rubber extending to an outer side in the tire width direction along an extending direction of the slit from the first conductive rubber layer and reaching a conductive rubber portion which is adjacent to the nonconductive tread rubber while cutting across the ground end, before vulcanizing the tire; and

a step of forming a tread pattern in which the first conductive rubber layer vertically cuts across the slit and the second conductive rubber layer is arranged within the slit, by vulcanizing the tire after forming the first conductive rubber layer and the second conductive rubber layer.

In accordance with the manufacturing method of the pneumatic tire on the basis of the present invention, first, the first conductive rubber layer and the second conductive layer are formed in the nonconductive tread rubber before vulcanizing the tire, and the conductive layer is provided linearly. The first conductive rubber layer is arranged along the tire circumferential direction within the ground surface of the shoulder portion, and the second conductive rubber layer is arranged in such a manner as to extend to the outer side in the tire width direction from the first conductive rubber layer and reach the conductive rubber portion. Any of the first conductive rubber layer and the second conductive rubber layer may be first formed, or they may be simultaneously formed. Further, they may be formed before or after forming the green tire.

Next, there is vulcanized the green tire provided with the nonconductive tread rubber mentioned above, and there is formed the tread pattern in which the first conductive rubber layer vertically cuts across the slit and the second conductive rubber layer is arranged within the slit. Since the second conductive rubber layer is arranged along the extending direction of the slit preliminarily before vulcanizing the tire, the second conductive rubber layer is arranged within the slit only by adjusting the relative positions of the green tire and the forming mold in the tire circumferential direction.

In the formed pneumatic tire, there is formed the conductive path reaching the road surface from the conductive rubber portion via the second conductive rubber layer and the first conductive rubber layer, by the linear conductive layer constituted by the first and second conductive rubber layers. Accordingly, it is possible to suitably discharge the static electricity generated in the vehicle body to the road surface, and it is possible to prevent the problem such as the radio noise or the like from being generated. Further, in the first and second conductive rubber layers formed with the filament conductive rubber, since a thickness thereof becomes larger in comparison with the thin film shaped conductive layer constituted by the rubber paste or the like, it is possible to suppress a segmentation caused by pressing the mold surface of the forming mold, and it is possible to suitably achieve a conductive performance. Further, since the first conductive rubber layer of the slit wall surface and the second conductive rubber layer within the slit are left without disappearing even in a stage that the wear of the tread rubber makes progress and the first conductive rubber layer of the road surface disappears, it is possible to suitably maintain the conductive performance regardless of the wear state of the tread rubber.

In the above method, it is preferable that the second conductive rubber layer is arranged in a bottom surface of the slit, in the step of forming the tread pattern. Accordingly, it is possible to suitably maintain the conductive performance to the end of the wear regardless of the wear state of the tread rubber.

In the above method, it is preferable that the first conductive rubber layer and the second conductive rubber layer are formed by using the filament conductive rubber in which a width and a thickness are equal to or more than 0.5 mm. Accordingly, it is possible to securely suppress the segmentation of the first and second conductive rubber layer caused by pressing the mold surface of the forming mold, and it is possible to stably achieve the conductive performance.

Further, the present invention provides a pneumatic tire comprising:

a nonconductive tread rubber in which a slit is formed so as to extend to an outer side in a tire width direction while cutting across a ground end from an inner side of a ground surface of a shoulder portion;

a first conductive rubber layer formed with a filament conductive rubber and extending in a tire circumferential direction within the ground surface of the shoulder portion of the nonconductive tread rubber so as to vertically cut across the slit; and

a second conductive rubber layer formed with a filament conductive rubber, branching from the first conductive rubber layer within the slit so as to extend to an outer side in the tire width direction, and reaching a conductive rubber portion which is adjacent to the nonconductive tread rubber while cutting across the ground end.

In accordance with the pneumatic tire on the basis of the present invention, since the first conductive rubber layer and the second conductive rubber layer are provided as mentioned above, it is possible to construct the conductive path reaching the road surface from the conductive rubber portion via the second conductive rubber layer and the first conductive rubber layer, and it is possible to suitably discharge the static electricity generated in the vehicle body to the road surface. Further, in the first and second conductive rubber layers formed with the filament conductive rubber, since a thickness thereof becomes larger in comparison with the thin film shaped conductive layer constituted by the rubber paste or the like, it is possible to suppress a segmentation caused by pressing the mold surface of the forming mold, and it is possible to suitably achieve a conductive performance. Further, since the first conductive rubber layer of the slit wall surface and the second conductive rubber layer within the slit are left without disappearing even in a stage that the wear of the tread rubber makes progress and the first conductive rubber layer of the road surface disappears, it is possible to suitably maintain the conductive performance regardless of the wear state of the tread rubber.

Further, in the present invention, since the first and second conductive rubber layer are formed with the filament conductive rubber, the rate of the conductive rubber with respect to the nonconductive tread rubber does not become more than necessary. Accordingly, the improving effect caused by making the tread rubber nonconductive is not deteriorated, and in the case that the tread rubber is high blended with silica, it is possible to achieve excellent fuel consumption performance and wet braking performance.

In the above structure, it is preferable that the second conductive rubber layer is arranged in a bottom surface of the slit. Accordingly, it is possible to suitably maintain the conductive performance to the end of the wear regardless of the wear state of the tread rubber.

### BRIEF DESCRIPTION OF THE DRAWINGS

FIG. 1 is a half cross sectional view of a tire meridian showing an example of a pneumatic tire in accordance with the present invention;

FIG. 2 is an expansion plan view showing an example of a tread pattern;

FIG. 3 is a perspective view of a main portion showing a portion near a slit of a tread rubber; and

FIG. 4 is a perspective view showing a connection state between the tread rubber and a strip rubber before vulcanizing the tire.

### DETAILED DESCRIPTION OF THE PREFERRED EMBODIMENTS

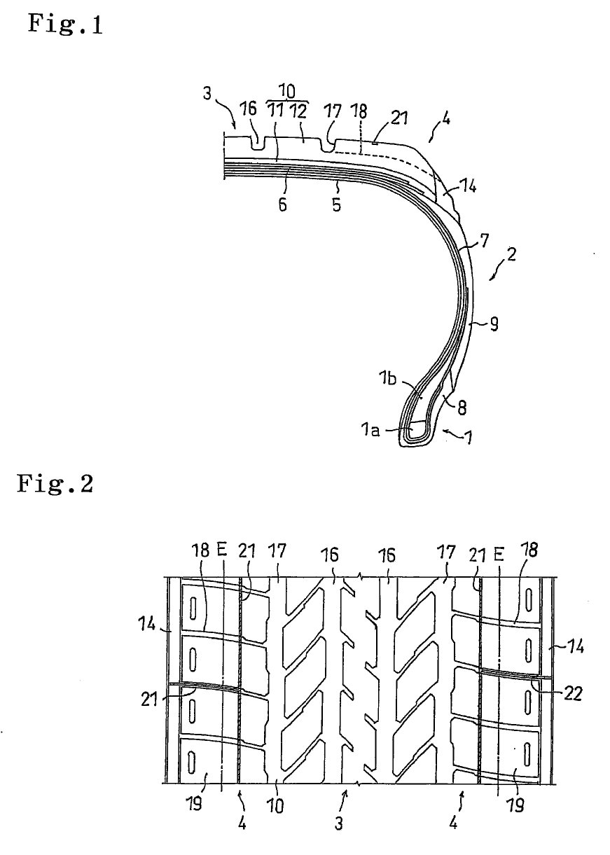

An embodiment of the present invention will be explained with reference to the drawings. FIG. 1 is a half cross sectional view of a tire meridian showing an example of a pneumatic tire in accordance with the present invention. The pneumatic tire comprises a pair of bead portions 1, sidewall portions 2 extending from respective bead portions 1 radially outward of the tire, and tread portions 3 connected to the respective sidewall portions 2 radially outward of the tire through a shoulder portion 4. In the bead portion 1, an annular bead 1a formed by coating a convergence body of steel wire with rubber, and a bead filler 1b made of hard rubber are disposed.

A carcass layer 7 is constituted by at least one (two in the present embodiment) carcass ply, and is arranged in such a manner as to bridge between the bead portions 1. An inner liner layer 5 for holding an air pressure is arranged in an inner side of the carcass layer 7, and a belt layer 6 constituted by two belt plies laminated inside and outside and carrying out a reinforcement on the basis of a hoop effect is arranged in an outer side of the tread portion 3 of the carcass layer 7. Further, a strip rubber 8 is arranged in an outer side of the bead portion 1 of the carcass layer 7, and a side wall rubber 9 is arranged in an outer side of the side wall portion 2 in the same manner.

A nonconductive tread rubber 10 (hereinafter, refer simply to as a tread rubber 10) is arranged in an outer periphery of the belt layer 6, and a tread pattern shown in FIG. 2 is formed on a surface thereof. In the present embodiment, a strip rubber 14 formed as a triangular cross sectional shape is arranged in adjacent to an outer side in a tire width direction of the tread rubber 10. The rim strip rubber 8, the side wall rubber 9 and the strip rubber 14 are formed with a conductive rubber in which a carbon black is blended as a reinforcing agent in a raw material rubber at a high rate, in the same manner as the normal pneumatic tire. In the present embodiment, the strip rubber 14 corresponds to “conductive rubber portion adjacent to the tread rubber”.

The tread rubber 10 has a cap and base structure provided with a base rubber 11 arranged in an outer circumference of the belt layer 6, and a cap rubber 12 arranged in an outer circumference of the base rubber 11 and constructing a tire outer circumferential side portion of the tread portion 3. The cap rubber 12 is formed with a non-conductive rubber in which a silica is blended as the reinforcing agent in the raw material rubber at a high rate, thereby achieving the excellent fuel consumption performance and wet braking performance. The base rubber 11 may be formed with the conductive rubber, and can be formed with the nonconductive rubber in the present invention. Accordingly, it is possible to make both the base rubber 11 and the cap rubber 12 is high blended with the silica as mentioned above. In the case mentioned above, it is possible to effectively reduce a rolling resistance of the tire so as to well improve the fuel consumption performance.

The conductive rubber is exemplified by the conductive rubber indicating a conductivity in which a specific volume resistance is less than 10⁸ Ωcm, and can be obtained by blending a predetermined amount of known conductivity applying material such as a carbon including a carbon fiber, a graphite and the like, or a metal including a metal powder, a metal oxide, a metal flake, a metal fiber and the like in addition to the carbon black. Further, the nonconductive rubber is exemplified by the nonconductive rubber in which the specific volume resistance is equal to or more than 10⁸ Ωcm.

Examples of raw material rubbers for the conductive rubber and the nonconductive rubber are natural rubber, styrene-butadiene rubber (SBR), butadiene rubber (BR), isoprene rubber (IR), butyl rubber (IIR) and the like. These rubbers are used alone or a combination thereof. These rubbers are appropriately mixed with cure, accelerator, plasticizer, antioxidant or the like.

The tread pattern formed in the tread rubber 10 includes main grooves 16 and 17 extending in a tire circumferential direction, and a slit 18 (a horizontal groove) extending so as to intersect the main groove 17, as shown in FIG. 2. The slit 18 extends to an outer side in a tire width direction so as to cut across a ground end E from an inner side of a ground surface of the shoulder portion 4, and comparts a land portion into a plurality of shoulder blocks 19. In the present embodiment, there is shown an example in which the slit 18 extends so as to be inclined with respect to the tire width direction while gently curving.

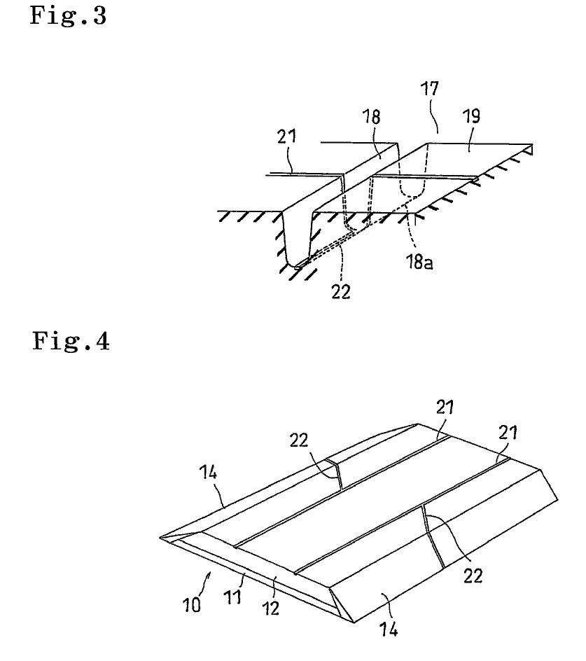

A first conductive rubber layer 21 extending along the tire circumferential direction so as to vertically cut across the slit 18 is provided within the ground surface of the shoulder portion 4. In the present embodiment, one first conductive rubber layer 21 is provided in each of the shoulder portions 4 in both sides in the tire width direction so as to be formed as a straight shape along the tire circumferential direction and as an annular shape. Further, as shown in FIGS. 2 and 3, there is provided a second conductive rubber layer 22 branching from the first conductive rubber layer 21 within the slit 18 so as to extend to an outer side in the tire width direction and reaching the strip rubber 14 while cutting across the ground end E. The first conductive rubber layer 21 and the second conductive rubber layer 22 are formed with a filament conductive rubber obtained by forming the conductive rubber mentioned above in a filament shape by an extruding machine or the like.

Accordingly, the conductive path reaching the road surface from the strip rubber 14 via the second conductive rubber layer 22 and the first conductive rubber layer 21 is structured. Therefore, it is possible to discharge the static electricity generated in the vehicle body to the road surface so as to prevent the problem such as the radio noise or the like from being generated. In this case, in detail, the static electricity generated in the vehicle body is discharged to the road surface from a rim (not shown) via the rim strip rubber 8, the side wall rubber 9, the strip rubber 14, the second conductive rubber layer 22 and the first conductive rubber layer 21.

Since the first conductive rubber layer 21 and the second conductive rubber layer 22 are formed with the filament conductive rubber as mentioned above, and have a larger thickness in comparison with the conventional thin film shaped conductive layer constituted by the rubber paste or the like, it is possible to suppress the segmentation caused by pressing the mold surface of the forming mold so as to suitably achieve the conductive performance. Further, since the first conductive rubber layer 21 of the slit 18 wall surface and the second conductive rubber layer 22 within the slit 18 are left without disappearing as is understood from FIG. 3 even in a stage that the wear of the tread rubber 10 makes progress and the first conductive rubber layer 21 of the tread surface disappears, it is possible to suitably maintain the conductive performance regardless of the wear state of the tread rubber 10.

It is sufficient that a cross sectional shape and a size of the first conductive rubber layer 21 and the second conductive rubber layer 22 are secured in such a degree that the demanded conductive performance is suitably achieved, however, there is exemplified a structure in which a width is between 0.5 and 0.6 mm and a thickness is between 0.5 and 0.6 mm, as a preferable embodiment.

It is preferable that at least one first conductive rubber layer 21 is provided in each of the shoulder portions 4 in both sides in the tire width direction. Accordingly, it is possible to suitably maintain the conductive performance even in the case that an irregular wear is generated in the tread portion 3. Further, it is preferable that the first conductive rubber layer 21 is provided annularly along the tire circumferential direction, whereby a contact with the road surface can be secured regardless of the rotating direction of the tire. Accordingly, it is possible to suitably achieve the conductive performance.

The number of the second conductive rubber layer 22 is not particularly limited as far as the demanded conductive performance is suitably achieved, however, it is preferable that at least one second conductive rubber layer 22 is provided within the ground length of the tread portion 3, in the light of suitably achieving the conductive performance. Further, the second conductive rubber layer 22 may be arranged on the wall surface of the slit 18 as far as being within the slit 18, however, it is preferable that the second conductive rubber layer 22 is arranged in the bottom surface 18a of the slit 18 such as the present embodiment. Accordingly, it is possible to suitably maintain the conductive performance to the end of the wear regardless of the wear state of the tread rubber 10.

The pneumatic tire in accordance with the present invention is equal to the normal pneumatic tire except the provision of the nonconductive tread rubber and the first and second conductive rubber layers as mentioned above, and the conventionally known material, shape, structure and the like can be applied to the present invention. In addition, in the present invention, it is possible to appropriately employ the other tread patterns than that shown in FIG. 2, as far as the slit is formed so as to extend to the outer side in the tire width direction while cutting across the ground end from the inner side of the ground surface of the shoulder portion.

The pneumatic tire in accordance with the present invention can be manufactured by the conventionally known method except the point that the nonconductive tread rubber mentioned above and the first and second conductive rubber layers are provided. A description will be given below of a manufacturing method of the pneumatic tire particularly about a formation of the tread rubber and a tire vulcanizing. FIG. 4 is a perspective view showing a connected state of the tread rubber 10 and the strip rubber 14 before vulcanizing the tire. In this case, the actual tread rubber 10 is longer than the illustrated one, and is formed as an annular shape after forming the green tire.

First, there is formed the tread rubber 10 and the strip rubber 14 having the predetermined cross sectional shapes so as to set a state in which the first conductive rubber layer 21 and the second conductive rubber layer 22 are not formed in FIG. 4. This step is carried out, for example, by simultaneously extruding three layers comprising the base rubber 11, the cap rubber 12 and the strip rubber 14 or applying the strip rubber 14 to a side portion of the tread rubber 10 formed in accordance with a conventionally known extruding method or ribbon winding method.

Next, the first conductive rubber layer 21 and the second conductive rubber layer 22 are formed so as to be set to a state shown in FIG. 4. In other words, the first conductive rubber layer 21 is formed with arranging the filament conductive rubber within the region forming the ground surface of the shoulder portion 4 of the tread rubber 10 along the tire circumferential direction, and the second conductive rubber layer 22 is formed with arranging the filament conductive rubber in such a manner as to extend to the outer side in the tire width direction from the first conductive rubber layer 21 and reach the strip rubber 14 while cutting across the ground end E. At this time, the filament conductive rubber forming the second conductive rubber layer 22 is arranged along the extending direction of the slit 18.

Subsequently, the green tire provided with the tread rubber 10 is vulcanized. In this step, the tread pattern corresponding to the concavo-convex shape provided in the mold surface is formed with pressing the mold surface of the forming mold to the surface of the tread rubber 10. In the present invention, there is formed the tread pattern in which the first conductive rubber layer 21 vertically cuts across the slit 18 as shown in FIG. 2, and the second conductive rubber layer 22 arranged within the slit 18. The tread pattern mentioned above can be formed with adjusting the relative position between the green tire and the forming mold so as to make the convex portion corresponding to the slit 18 in line with the position of the second conductive rubber layer 22 in the tire circumferential direction.

In the present invention, since the first conductive rubber layer 21 and the second conductive rubber 22 are formed with the filament conductive rubber, it is possible to make the thickness larger in comparison with the conventional thin film shaped conductive layer constituted by the rubber paste or the like, and it is possible to suppress the segmentation caused by pressing the mold surface of the forming mold. The size and the cross sectional shape of the filament conductive rubber are not particularly limited as far as the conductive performance can be suitably achieved, however, in order to preferably obtain the segmentation suppressing effect mentioned above, it is preferable that the width and the thickness are equal to or more than 0.5 mm. Further, it is preferable that the filament conductive rubber is formed as a circular cross sectional shape in the light of the formability, and a diameter in this case is preferably between 0.5 and 3 mm, and more preferably between 0.5 and 1 mm.

### Other Embodiments

(1) In the embodiment mentioned above, there is shown the embodiment in which the strip rubber is provided as the conductive rubber portion which is adjacent to the nonconductive tread rubber, however, it is possible to employ a so-called side-wall on-tread structure in which the outer end portion in the tire diametrical direction of the side wall is arranged in adjacent to the outer side of the tread rubber in the tire width direction, in place of the structure mentioned above. In this case, the side wall rubber corresponds to “conductive rubber portion which is adjacent to the tread rubber”.

(2) In the embodiment mentioned above, there is shown the embodiment in which the tread rubber has the cap and base structure, however, the present invention is not limited to this. Accordingly, the nonconductive tread rubber may be formed with the one-layer rubber layer constituted by the nonconductive rubber.

What is claimed is:

1. A manufacturing method of a pneumatic tire for forming a tread pattern including a slit extending to an outer side in a tire width direction while cutting across a ground end from an inner side of a ground surface of a shoulder portion by pressing a mold surface of a forming mold to a surface of a tread rubber at a time of vulcanizing the tire, comprising:
a step of forming a first conductive rubber layer by arranging a filament conductive rubber within the ground surface of the shoulder portion of a nonconductive tread rubber so as to be along a tire circumferential direction, before vulcanizing the tire;
a step of forming a second conductive rubber layer by arranging a filament conductive rubber extending to an outer side in the tire width direction along an extending direction of the slit from the first conductive rubber layer and reaching a conductive rubber portion which is adjacent to the nonconductive tread rubber while cutting across the ground end, before vulcanizing the tire; and
a step of forming a tread pattern in which the first conductive rubber layer vertically cuts across the slit and the second conductive rubber layer is arranged within the slit, by vulcanizing the tire after forming the first conductive rubber layer and the second conductive rubber layer.

2. A manufacturing method of a pneumatic tire according to claim 1, wherein the second conductive rubber layer is arranged in a bottom surface of the slit, in the step of forming the tread pattern.

3. A manufacturing method of a pneumatic tire according to claim 1, wherein the first conductive rubber layer and the second conductive rubber layer are formed by using the filament conductive rubber in which a width and a thickness are equal to or more than 0.5 mm.

4. A pneumatic tire comprising:
a nonconductive tread rubber in which a slit is formed so as to extend to an outer side in a tire width direction while cutting across a ground end from an inner side of a ground surface of a shoulder portion;
a first conductive rubber layer formed with a filament conductive rubber and extending in a tire circumferential direction within the ground surface of the shoulder portion of the nonconductive tread rubber so as to vertically cut across the slit; and
a second conductive rubber layer formed with a filament conductive rubber, branching from the first conductive rubber layer within the slit so as to extend to an outer side in the tire width direction, and reaching a conductive rubber portion which is adjacent to the nonconductive tread rubber while cutting across the ground end.

5. A pneumatic tire according to claim 4, wherein the second conductive rubber layer is arranged in a bottom surface of the slit.
